(19) United States
(12) Patent Application Publication
(10) Pub. No.: US 2024/0227275 A1
(43) Pub. Date: Jul. 11, 2024

(54) Stretching rod for forming containers

(71) Applicant: SIDEL PARTICIPATIONS, Octeville-sur-Mer (FR)

(72) Inventor: Laurent NAVEAU, OCTEVILLE-SUR-MER (FR)

(21) Appl. No.: 18/132,538

(22) Filed: Apr. 10, 2023

(30) Foreign Application Priority Data
Apr. 13, 2022 (FR) 2203422

(51) Int. Cl. B29C 49/12; B29L 31/00

(52) U.S. Cl. CPC B29C 49/1215; B29L 2031/7158

(57) ABSTRACT

The present invention relates to a stretching rod (1) for a molding unit (15) for manufacturing a container (2) from a preform (3) and to a method for manufacturing a container (2) by stretch blow molding. 5

Said stretching rod (1) extends longitudinally, parallel to a main axis Y, and comprises a body (4) of cylindrical or tubular form, a distal end (5) in the continuation of said body (4), a flat (6) situated at the distal end (5) of the stretching rod (1) and an end fitting (7) protruding from said flat (6). Said rod (1) is characterized in that it comprises an annular skirt (8) in the continuation of said body (4), at said distal end (5), said skirt 10 (8) having a height (80) less than the height (70) of said end fitting (7).

### TECHNICAL FIELD

The present invention relates to the field of the manufacture of containers by blow molding or stretch blow molding from preforms made of thermoplastic material, such as polyethylene terephthalate, hereinafter “PET”. The subject of the invention is more particularly a stretching rod intended to be implemented in a stretch-blow-molding technique for forming containers. Another subject of the invention is a method for manufacturing containers implementing the stretching rod according to the invention.

### PRIOR ART

It is known practice to form containers made of thermoplastic material by stretch blow molding of preforms that are previously heated to a temperature that is sufficient to soften the walls thereof.

To this end, a forming device is used which comprises a mold having a cavity shaped with the impression of the container to be obtained. The previously heated preform is received in the cavity. Then, its walls are subjected to what is referred to as “biaxial” stretching so as to conform to the impression of the mold. For this, the preform is stretched axially by means of a stretching rod to provoke the axial expansion of the preform. Simultaneously with this stretching operation, a pressurized fluid is injected into the preform so as to provoke the radial expansion of the wall.

Such a forming method is well known. For the final container to have a perfectly molded bottom, it is preferable for the stretching rod to be adapted to guarantee a satisfactory thickness of the wall of the container. A bad distribution of the material is a recurrent defect found on the containers produced by a method of molding and stretching/blowing. It is not necessarily a case of ensuring that the thickness of the wall of the container is constant, because in certain cases it may be desirable to thicken certain zones, in particular those intended to be subjected to significant stresses (notably in the vicinity of the bottom). It is rather a case of ensuring that the thickness of material corresponds to the specifications of the container, as defined according to its form and its use.

Methods have thus been developed to promote a distribution of the material matched to demanding specifications.

Furthermore, in the field of the manufacture of containers by molding and stretching/blowing, use is increasingly being made of recycled PET, for environmental reasons. This material further increases the problem of distribution of the material because it exhibits different heat absorption properties.

Moreover, despite the details provided for the stretch-blow-molding methods, notably aiming to improve the distribution of the material at the bottom of the blown container, there are still problems. In particular, the design of the rod will have an impact on the material distribution, and also on the temperature induced inside the container, upon contact of the rod with the container.

There may then be a problem with centering, with material distribution, and with pronounced collapse of the bottom upon exiting the mold.

### TECHNICAL BACKGROUND

Document U.S. Pat. No. 9,085,099 proposes improving the blow-molding method of the patents by temporarily fastening the stretching rod to the bottom of the preform. This method necessitates a step of suctioning the bottom of the preform which may lead to other problems. Document FR3022824 proposes a stretching rod of widened form. This rod poses problems when being inserted into the preform because it may touch the inner walls, and it is very restricting in terms of preform formats.

Document EP1063076 is also known which describes a stretching rod for a molding unit for manufacturing a container from a preform, said stretching rod extending longitudinally, parallel to a main axis, comprising a body of cylindrical or tubular form; a distal end in the continuation of said body; a flat situated at the distal end of the stretching rod, and; an end fitting protruding from said flat; an annular skirt in the continuation of said body, at said distal end, said skirt having a height less than the height of said end fitting. The diameter of the skirt is very much greater than the diameter of the body of the stretching rod such that the large-diameter skirt presses the corner portion, said corner portion being the portion of the preform connecting the body of the preform to the bottom of said preform.

### SUMMARY OF THE INVENTION

The current solutions are not satisfactory, and there is a need to further improve the stretch-blow-molding step in order to obtain containers of better quality with regard to the centering of the bottle and the distribution of the material.

The invention aims to solve this problem and, to this end, proposes a stretching rod which ensures stretching of the preform along its axis, by avoiding undesirable contact between the outside of the rod and the inside of the body of the preform, while improving the centering of said rod and thus reducing the transfers of heat between the rod and the preform.

To this end, the invention relates to a stretching rod for a molding unit for manufacturing a container from a preform, said stretching rod extending longitudinally, parallel to a main axis Y, comprising
a body of cylindrical or tubular form;
a distal end in the continuation of said body;
a flat situated at the distal end of the stretching rod, and;
an end fitting protruding from said flat.

The stretching rod according to the invention is characterized in that it comprises an annular skirt in the continuation of said body, at said distal end, said skirt having a height less than the height of said end fitting, said end fitting having a diameter smaller than the diameter of the body of the stretching rod, and the diameter of the free end of the skirt being smaller than or equal to 14 mm.

Preferably, said skirt has a diameter smaller than or equal to the diameter of the body of the stretching rod.

According to an additional feature, the edges of the annular skirt and/or of the end of the end fitting are rounded. According to another feature, the outer body and the annular skirt comprise a single piece. According to an additional feature, the end fitting is of conical form. According to another feature, the flat extends orthogonally with respect to the main axis Y.

The annular skirt may have a crenelated form. The annular skirt may have a crenelated form with rounded and convex peak edges and concave trough edges.

The invention also relates to a method for manufacturing a container by stretch blow molding implementing the stretching rod according to the invention, comprising at least the following steps of
placing a previously heated preform in a blowing mold having, in closure position, a molding cavity forming the impression of the container to be blown;
closing said blowing mold;
blowing said preform in the blowing mold by way of a blowing nozzle and, substantially simultaneously, a step of stretching said preform by insertion of the stretching rod inside said preform by bearing against the bottom of said preform so as to facilitate the axial elongation of said preform;
retracting said stretching rod;
extracting said blown container by opening said blowing mold.

### BRIEF DESCRIPTION OF THE FIGURES

The invention will be understood better from the description below which is based on possible embodiments, explained illustratively and in a non-limiting manner, with reference to the attached figures, in which:

FIG. 1 schematically shows a simplified top view of one exemplary embodiment of a molding machine of rotary type, notably illustrating the molding units (without the blowing and stretching means) distributed around a carousel, said blowing units being, depending on their relative position with respect to the input or the output of the machine, in open position or in closed position;

FIG. 2 schematically shows a partial perspective view of one of the molding units of the machine according to the exemplary embodiment in FIG. 1, notably illustrating, outside of the unit in open position, an exploded view of a mold produced in three parts, namely two half-molds and a mold bottom;

FIG. 3 schematically shows a vertical longitudinal median cross-sectional view of a molding unit of the machine, during a first step of a container blowing cycle, notably showing the insertion of the distal end of the rod into a preform enclosed within a mold;

FIG. 4 schematically shows a view similar to FIG. 3, during another subsequent step at the end of the blowing cycle, notably showing the distal end of the rod introduced into the blown container and extending to the bottom of said blown container;

FIG. 5 schematically shows a perspective view of a first embodiment of the distal end of the stretching rod, notably showing an annular skirt having rounded edges;

FIG. 6 schematically shows a longitudinal median cross-sectional view of the first embodiment in FIG. 5;

FIG. 7 schematically shows a longitudinal median cross-sectional view of a second embodiment of the distal end of the stretching rod, notably showing an annular skirt having straight and beveled edges;

FIG. 8 schematically shows a longitudinal median cross-sectional view of a third embodiment of the distal end of the stretching rod, notably showing the annular skirt having a crenelated form with rounded and convex peak edges and concave trough edges;

FIG. 9 schematically shows a longitudinal median cross-sectional view of a fourth embodiment of the distal end of the stretching rod, notably showing the annular skirt with a profile converging from the body of said rod toward its distal end;

FIG. 10 schematically shows a side view of one embodiment of the distal end of the stretching rod, notably showing a skirt with an annular edge inscribed in a same plane, and also the end fitting and the flat in dotted lines;

FIG. 11 schematically shows another side view of another embodiment, showing a skirt with straight crenelated edges, with peaks and troughs; and

FIG. 12 schematically shows a side view of one embodiment, showing a skirt with rounded crenelated edges.

### DETAILED DESCRIPTION OF THE INVENTION

In the remainder of the description, elements exhibiting an identical structure or equivalent functions will be denoted by the same reference.

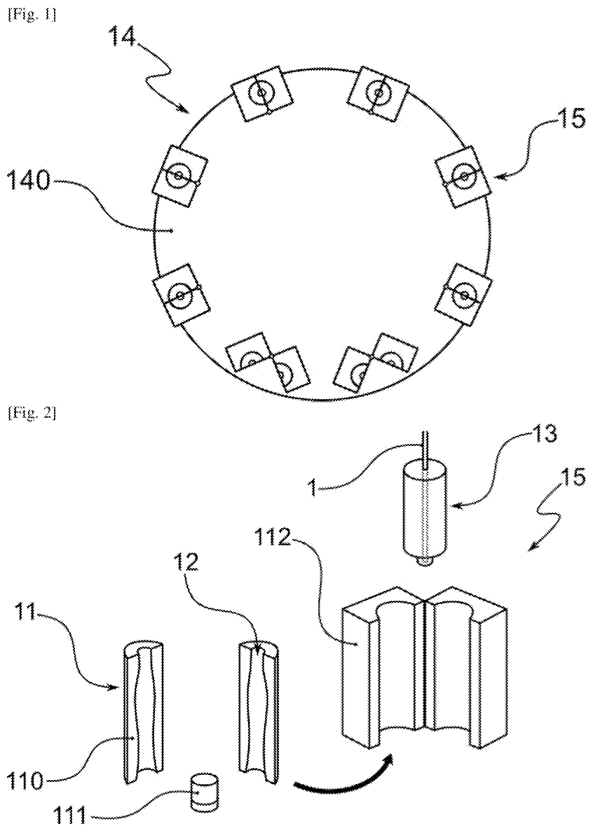

The invention is designed to be implemented in an installation for manufacturing containers 2. Such an installation comprises, normally, a molding machine 14 as shown in FIG. 1, comprising at least molding units 15, each molding unit 15 comprising at least blowing means incorporating a stretching rod 1, said mold 11 comprising at least two half-molds 110 which each have an inner molding face and which are respectively mounted on supports that are movable about an axis Y, between at least an open position and a closed position of the molding unit 15, in which said inner faces of said at least two joined half-molds 110 together delimit a molding cavity 12 for the container 2.

In practice, the blowing molds 11 are distributed circularly, in the form of a carousel 140, as can be seen in FIG. 1, and topped by respective blowing installations. In practice, always, and as can be seen in FIG. 2, the body of the blowing installation extends substantially vertically above the mold and substantially coaxially with the molding cavity 12 of the blowing mold 11.

FIG. 2 schematically shows a perspective view of one of the molding units 15 of the machine 14 according to the exemplary embodiment in FIG. 1, notably illustrating, outside of the unit 15 in open position, an exploded view of a mold 11 produced in three parts, namely two half-molds 110 and a mold bottom 111.

All these elements are well known to a person skilled in the art and are not described in detail for a better understanding of the invention.

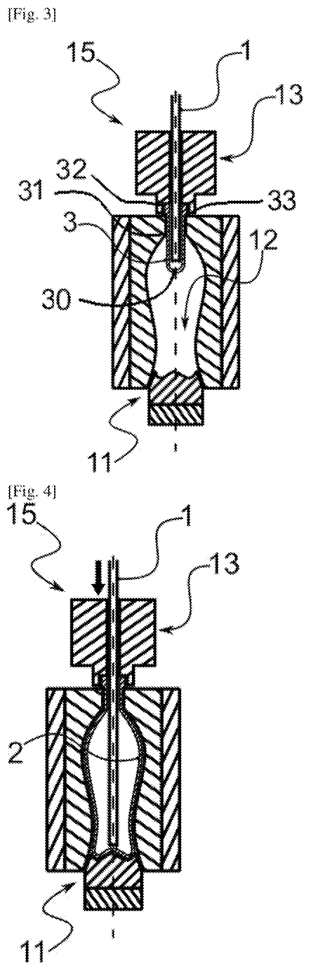

Reference is made to FIG. 3, showing a first embodiment of a rod 1 according to the invention, in a partial longitudinal cross-sectional view, which is implemented with a preform 3 made of PET or of recycled PET, intended to be stretched and blown in one of the blowing molds 11 of an installation described briefly above, so as to form a container 2, such as a bottle.

In FIG. 3, the stretching rod 1 is in high position and being inserted into the preform 3. The rod 1 is designed to be mounted in the body of the blowing installation also mentioned above. Said stretching rod 1 extends longitudinally, parallel to the main axis Y. The stretching rod 1 according to the invention is a solid stretching rod. It has a first end, referred to as proximal end (not shown), able to be secured to a displacement device internal to the manufacturing installation.

As can be seen in FIG. 3, the preform 3 comprises, in a conventional manner, a body of elongate and tubular form, of axis Y, limited by a wall 31 integral in the upper part with a threaded neck 32 and in the lower part with a substantially hemispherical bottom 30.

Between the neck 32 and the body of the preform, a radial collar 33 protrudes outward from the preform 3.

Generally, the preform 3 illustrated in FIG. 3 has symmetry of revolution about its axis Y.

When the preform is placed in the blowing installation, the axis Y of the rod 1 substantially coincides with the axis of revolution of the preform 3. Hereinbelow, Y will therefore be used without distinction to denote the axis of the rod 1 or that of the preform 3.

Hereinbelow, “vertical” will be used to qualify any direction parallel to the axis of revolution of the rod and “transverse” will be used to qualify any direction perpendicular to the axis of revolution of the rod.

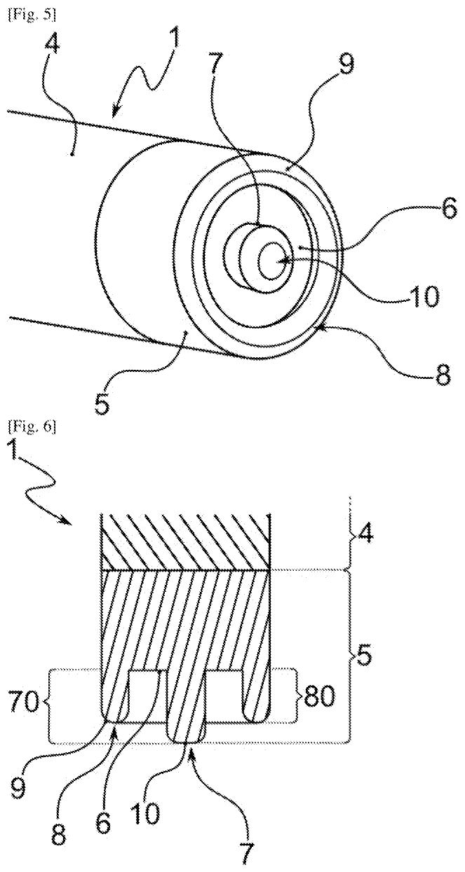

As shown in FIG. 5, the stretching rod 1 comprises a cylindrical or tubular body 4. In embodiments, the body 4 of the stretching rod 1 may have a shoulder, that is to say have two longitudinal sections having two different diameters. This is particularly advantageous for the blowing of preforms of small diameter.

In the continuation of the body 4, at the distal end 5, the stretching rod 1 comprises a flat 6. An end fitting 7 protrudes from this flat 6.

As can be seen in FIG. 5, the stretching rod 1 further comprises an annular skirt 8 in the continuation of its body 4.

FIG. 3 shows the step of inserting the stretching rod 1 into the blowing cavity 12.

FIG. 4 schematically shows another step of a blowing cycle, in which the stretching rod 1 is in low position and therefore placed at the bottom 30 of the preform 3 during the blowing step. During this step, the preform 3 becomes a container 2.

In embodiments, and as shown in FIG. 5, the diameter of the annular skirt 8 is equal to the diameter of the body 4 of the stretching rod 1. In this advantageous configuration, the centering is also improved. Specifically, during the stretching, the material flows into the trough of the skirt 8, thus tending to block it, thus avoiding any slippage and therefore allowing good centering.

In embodiments, the body 4 and the annular skirt 8 are obtained in a single piece. In other words, they form one and the same piece.

According to other embodiments, the body 4 and the annular skirt 8 are two separate pieces.

The structural modifications of the stretching rod 1 have the advantageous effect of making it possible to center the rod 1 perfectly in the preform 3 toward the bottom of the preform, over all of its lower surface, while limiting the diffusion of heat between said rod 1 and the bottom 30 of the preform 3, and thus of improving the stretch-blow-molding step.

The protruding end fitting 7 may be of any form. In particular, said end fitting 7 may be of conical form, of rounded conical form, of ovoid form, of hemispherical form, etc. Nevertheless, irrespective of the form of said end fitting 7, the latter is always inscribed in a cylinder whose diameter is smaller than the diameter of the body 4 of the stretching rod 1. According to a preferred embodiment, as shown in FIG. 5, the flat 6 is perpendicular to the body 4 of the stretching rod 1. This allows better distribution and better control of the blowing step.

FIG. 6 shows a longitudinal median cross-sectional view of one exemplary embodiment of the distal end of the stretching rod, notably showing an annular skirt 8 having rounded edges 9 and an end fitting 7 of cylindrical form. In this embodiment, the edges 9 of the annular skirt 8 are rounded. This is particularly advantageous because it makes it possible to avoid any risk of tearing if said edges 9 were to touch the wall of the preform 3, for example during the stretching phase.

In this exemplary embodiment, the annular skirt 8 has the same diameter as the diameter of the body 4 of the stretching rod 1. Nevertheless, the skirt 8 may have a smaller or greater diameter than the body 4 of the stretching rod 1 according to other embodiments. However, the diameter of the free end of the skirt 8 is always smaller than or equal to 14 mm such that said skirt 8 bears only against the bottom of the preform and never bears against the corner portion of the preform, said corner portion being the portion of the preform connecting the body of the preform to the bottom of said preform.

Furthermore, as can be seen in FIG. 6, the annular skirt 8 has a height 80 less than the height 70 of the end fitting 7 such that said end fitting 7 protrudes from the annular skirt 8. In other words, the distal end of the stretching rod 1 is formed by the end fitting 7 and the annular skirt 8 is an extension of the outer body 4 with respect to the flat 6. This therefore makes it possible to guarantee perfect centering of the rod 1 while limiting the diffusion of heat between said rod 1 and the preform 3 which then forms the container 2 at the end of the blowing step.

In a preferred embodiment, the height 80 of the annular skirt 8 is less than the height 70 of the end fitting 7 by a value of between 0.5 and 4 millimeters (mm), even more preferably by a value of 1 mm.

In embodiments, the height 80 of the annular skirt 8 varies all the way around its circumference. For example, the annular skirt 8 may have toothed or scalloped edges, and therefore have troughs and peaks, as can be seen in FIG. 11. Nevertheless, in this case, the height 80 remains less than the height 70 of the end fitting 7.

Any combination of form of edges 9 and of diameter of the annular skirt 8 is possible.

The presence of the annular skirt 8 according to the invention has the advantage of improving the stretch-blow-molding step considerably.

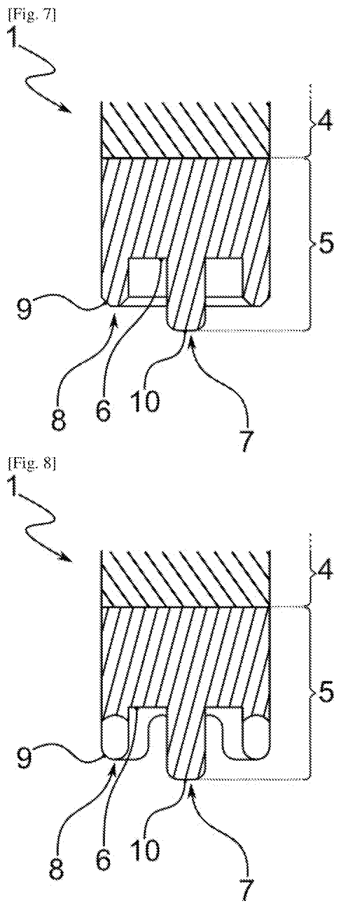

In embodiments, the annular skirt 8 of the stretching rod 1 has straight and beveled edges 9. This embodiment is illustrated in FIG. 7.

In one embodiment illustrated in FIG. 8, the annular skirt 8 has a crenelated form with rounded and convex peak edges 9 and concave trough edges.

In another variant, as illustrated in FIG. 9, the annular skirt 8 has a diameter converging from the body 4 of the rod 1 toward the protruding end fitting 7. In other words, its diameter decreases toward the free end portion and the annular skirt 8 therefore has a narrowed form. The annular skirt 8 has a section which decreases from the flat 6 up to its distal free end.

According to another variant (not shown), the diameter of the annular skirt 8 is greater than the diameter of the body 4 of the stretching rod 1. The annular skirt 8 then has a flared form. The expression “flared form” will be understood to mean a form whose section increases. Thus, a free end portion of annular skirt 8 of flared form means that the end portion of said skirt has a section which enlarges from the flat 6 up to its free end.

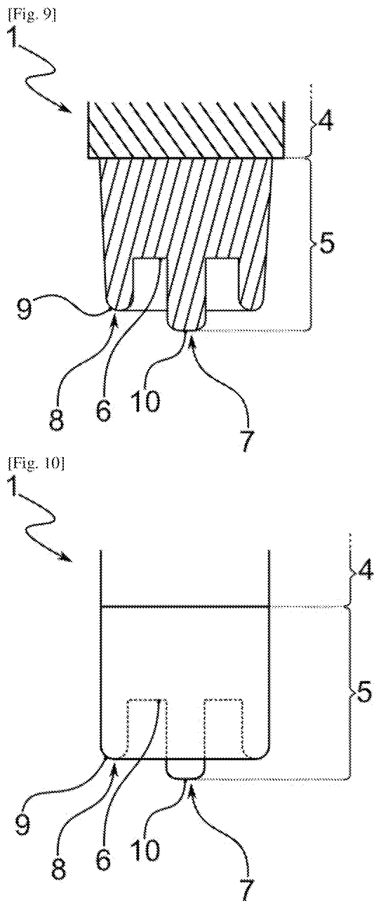

FIG. 10 schematically shows a side view of one embodiment of the distal end of the stretching rod, notably showing a skirt 8 with an annular edge inscribed in a same plane, and also the end fitting 7 and the flat 6 in dotted lines.

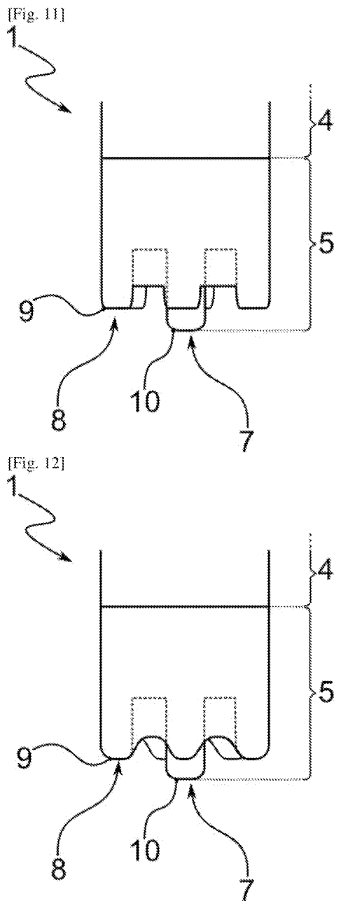

FIGS. 11 and 12 show embodiment variants of the annular skirt 8, having troughs and peaks.

FIG. 11 shows a skirt 8 with straight crenelated edges 9, with peaks and troughs, with a skirt height 80 that is always less than the height 70 of the end fitting 7.

FIG. 12 shows a skirt 8 having rounded crenelated edges 9.

The invention also relates to a method for manufacturing a container 2 by stretch blow molding implementing the stretching rod described above.

The manufacturing method according to the invention comprises at least the following steps of:
placing a previously heated preform 3 in a blowing mold 11 having, in closure position, a molding cavity 12 forming the impression of the container 2 to be blown;
closing said blowing mold 11;
blowing said preform 3 in the blowing mold 11 by way of a blowing nozzle 13 and, substantially simultaneously, a step of stretching said preform 3 by insertion of the stretching rod 1 inside said preform 3 by bearing against the bottom 30 of said preform 3 so as to facilitate the axial elongation of said preform 3;
retracting said stretching rod 1;
gripping the blown container 2 by external gripping means;
opening said blowing mold 11.

FIG. 1 shows a top view which schematically shows one exemplary embodiment of a molding machine 14 of rotary type and which illustrates the molding units 15 (without the blowing and stretching means) that are distributed circumferentially around the carousel 140 and that, depending on their relative position with respect to the input or the output of the machine 14, are in open position or in closed position.

A container 2 is manufactured by blowing of a hot preform 3 in a mold 11 of a molding unit 15 of the installation by means of at least one pressurized fluid, generally air.

In the exemplary embodiment, containers 2 are manufactured by stretch blow molding. The blowing means advantageously incorporate at least one stretching rod 1.

FIG. 2 schematically shows a partial perspective view of one of the molding units 15 of the machine according to the exemplary embodiment in FIG. 1, notably illustrating, outside of the unit in open position, an exploded view of a mold 11 produced in three parts, namely two half-molds 110 and a mold bottom 111. It is also possible to see the mold carrier 112, the nozzle 13 and the stretching rod 1.

The stretching rod 1 is driven axially, along the axis Y, in displacement by associated driving means (not shown).

The stretching rod 1 is therefore mounted to be able to slide axially so as to be introduced into the preform 3 through the opening delimited radially by its neck 32, an annular space being left free between the neck 32 and the rod 1 to allow passage of the blowing fluid.

The stretching rod 1 is mounted to be axially movable between at least a first, high position and a second, low position.

In the first position, the rod 1 extends outside the mold 11 and, in the second position, referred to as low position, the rod 1 is displaced downward so as to axially stretch the preform 3 inside the mold 11, during the blowing.

FIGS. 3 and 4 illustrate some of the steps for manufacturing a container 2 and the different positions of the stretching rod 1 during these steps.

A first step, as can be seen in FIG. 3, therefore relates to the introduction of a preform 3 into a blowing mold 11. The preform 3 has been previously heated to a temperature greater than the glass transition temperature of the material (which is approximately 80° C. in the case of PET).

Once the preform 3 is in position and the mold 11 is closed, as can be seen in FIG. 4, the stretching rod 1 is inserted into the preform 3, to come into the low position, that is to say that it is positioned on the bottom of the preform 3.

In a preferred embodiment, the low position of the stretching rod 1 corresponds to a position in which the end fitting 7 touches the bottom of the preform 3.

In other embodiments, the low position of the stretching rod 1 corresponds to a position in which the end fitting 7 is slightly set back from the bottom of the preform 3.

Substantially simultaneously with the insertion of the stretching rod 1 into the preform 3, the blowing step, or the stretch-blow-molding step, takes place during which a fluid (for example air) is injected into the preform 3, first at a median pressure, referred to as pre-blowing pressure, of between 5 bar and 15 bar, while displacing the stretching rod 1 from its high position to its deployed low position.

The blowing step ends with a momentary increase in pressure to an elevated pressure, greater than the pre-blowing pressure, to make sure that the material is well pressed against the cavity 12 of the blowing mold 11 and thus impart on it the impression of the container 2, as shown in FIG. 4. The blowing pressure is greater than or equal to 15 bar, and for example approximately 35 to 40 bar.

The stretching rod is maintained in the deployed position to avoid any unwanted slippage of material on the bottom of the mold as long as the pressure in the container has not reached the blowing pressure.

Lastly, at the end of the blowing step, the mold 11 is opened and the formed container 2 is discharged from it, completing the cycle. A new cycle can then begin with the introduction of a new preform 3.

The implementation of a stretching rod 1 according to the invention allows better control of the blowing step. Through this improved control, it is possible to increase the blowing rates, while limiting the diffusion of heat from the inside to the outside.

Furthermore, since the centering is effectively controlled due to the use of the stretching rod 1 according to the invention, the material distribution is therefore perfectly homogeneous, thus offering additional weight-saving potential, while limiting the risk of overstretching in the petaloid forms of the bottom, within the limit of generally recommended bi-orientation levels. Moreover, the reduction in the heating of the preform makes it possible to limit the risks of collapse.

Furthermore, the use of such a stretching rod 1 offers greater flexibility in the use of preforms, notably those whose form would not be perfectly suited to the bottle. It also makes it possible to minimize the contact between the rod 1 and the preform 3.

1. A stretching rod (1) for a molding unit (15) for manufacturing a container (2) from a preform (3), said stretching rod (1) extending longitudinally, parallel to a main axis Y, comprising:
a body (4) of cylindrical or tubular form;
a flat (6) situated at a distal end (5) of the stretching rod (1), and;
an end fitting (7) protruding from said flat (6);
wherein said rod (1) comprises an annular skirt (8) in continuation of said body (4), at said distal end (5), said annular skirt (8) having a height (80) less than the height (70) of said end fitting (7), said end fitting (7) having a diameter smaller than a diameter of the body (4) of the stretching rod (1), and a diameter of a free end of the skirt (8) being smaller than or equal to 14 mm.

2. The stretching rod (1) as claimed in claim 1, wherein said annular skirt (8) has a diameter smaller than or equal to the diameter of the body (4) of the stretching rod (1).

3. The stretching rod (1) as claimed in claim 1, wherein edges (9) of said annular skirt (8) are rounded, wherein an end (10) of said end fitting (7) is rounded, or both.

4. The stretching rod (1) as claimed in claim 1, wherein an outer surface of the body (4) and the skirt (8) comprise a single piece.

5. The stretching rod (1) as claimed in claim 1, wherein the end fitting (7) is of conical form.

6. The stretching rod (1) as claimed in claim 1, wherein the flat (6) extends orthogonally with respect to the main axis Y.

7. The stretching rod (1) as claimed in claim 1, wherein the annular skirt (8) has a crenelated form.

8. The stretching rod (1) as claimed in claim 7, wherein the annular skirt (8) has a crenelated form with rounded and convex peak edges (9) and concave trough edges (9).

9. A method for manufacturing a container (2) by stretch blow molding implementing the stretching rod (1) as claimed in claim 1, comprising:
placing a previously heated preform (3) in a blowing mold (11) having, in closure position, a molding cavity (12) forming the impression of the container (2) to be blown;
closing said blowing mold (11);
blowing said preform (3) in the blowing mold (11) by way of a blowing nozzle (13);
stretching said preform (3) by insertion of the stretching rod (1) inside said preform (3) by bearing against a bottom (30) of said preform (3) so as to facilitate the axial elongation of said preform (3) wherein the stretching occurs substantially simultaneously with the blowing;
retracting said stretching rod (1); and
extracting said blown container (2) by opening said blowing mold (11).
